(19) United States
(12) Patent Application Publication
(10) Pub. No.: US 2026/0329692 A1
(43) Pub. Date: Oct. 22, 2026

(54) USING PARITY BITS IN A DATA BURST SEQUENCE TO INDICATE FAULT MODE REGISTER INFORMATION

(71) Applicant: Micron Technology, Inc., Boise, ID (US)

(72) Inventor: Scott E. SCHAEFER, Boise, ID (US)

(21) Appl. No.: 19/468,287

(22) Filed: Feb. 3, 2026

Related U.S. Application Data
(60) Provisional application No. 63/782,814, filed on Apr. 3, 2025.

(51) Int. Cl. G06F 11/10

(52) U.S. Cl. CPC G06F 11/1048; G06F 11/1004

(57) ABSTRACT

Implementations described herein relate to using parity bits in a data burst sequence to indicate fault mode register information. In some implementations, a memory device may identify a configuration that defines one or more parity bits to be associated with fault mode register information. The memory device may transmit, to a host device, a data burst sequence that includes a plurality of parity bits, wherein the plurality of parity bits includes the one or more parity bits to indicate the fault mode register information in accordance with the configuration.

### TECHNICAL FIELD

This Patent Application claims priority to U.S. Provisional Patent Application No. 63/782,814, filed on Apr. 3, 2025, entitled “USING PARITY BITS IN A DATA BURST SEQUENCE TO INDICATE FAULT MODE REGISTER INFORMATION,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to using parity bits in a data burst sequence to indicate fault mode register information.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of using parity bits in a data burst sequence to indicate fault mode register information.

FIG. 2 is a diagrammatic view of an example memory device.

FIG. 3 is a diagram illustrating an example of a data burst sequence.

FIG. 4 is a diagram illustrating an example associated with using parity bits in a data burst sequence to indicate fault mode register information.

FIG. 5 is a flowchart of an example method associated with using parity bits in a data burst sequence to indicate fault mode register information.

### DETAILED DESCRIPTION

A memory device, such as a DRAM device, may support a data burst sequence that outputs 256 bits of data (e.g., payload data or mission data) and 32 bits of metadata. The 32 bits of metadata include 16 bits for system meta carve out and 16 bits for link error correction code (ECC) and/or error detection code (EDC) (ECC/EDC) or data bus inversion (DBI). The 16 bits for system meta carve out may be a reservation of system resources for system-level operations. The bits for system meta carve out may be enabled or disabled. The link ECC/EDC may be error correction code or error detection code. DBI involves inverting data bits when certain conditions are satisfied to reduce a number of transitions on a data bus, which may reduce power consumption and electromagnetic interference. The 16 bits for link ECC/EDC or DBI may be used for link ECC/EDC, DBI, or nothing. The 16 bits for link ECC/EDC may enable error detection and correction for the data burst sequence during transmission between a host device and the memory device, or between the memory device and the host device. The 16 bits for link ECC/EDC may protect a link between the host device and the memory device. The host device and the memory device may use the same mapping and/or ECC/EDC coding (e.g., H-matrix), where a mismatch may result in a nonvalid operation. In other words, each of the 16-bits allocation of use may be predetermined.

The memory device may employ an alert signal to provide a fault notification. When a fault (or error) is encountered by the memory device, the host device may be provided with the fault notification. One fault signal may be employed for a number of different types of faults (or errors) (e.g., one fault signal for any error). After the fault is detected, the host device may wait for the memory device to send the alert signal. The host device may receive the alert signal (after some delay) and then interrogate a plurality of devices to determine a source of the fault. For example, a board may have four dies, and each die may have two sub-channels (e.g., total of 8 sub-channels). The host device, via an interrogation, may read all 8 sub-channels to determine the source of the fault, which may take an inordinate amount of time. In other words, since only one fault signal may be employed, the host device may need to interrogate all devices to determine which die and/or sub-channel had the fault, which may consume the inordinate amount of time. The inordinate amount of time may increase an amount of time needed for the fault to be resolved by the host device, thereby degrading an overall system performance.

In some implementations, a memory device, such as a DRAM device, may identify a configuration that defines one or more parity bits to be associated with fault mode register information. The memory device may receive the configuration from a host device. Alternatively, the memory device may be preconfigured with the configuration. The configuration may define a number of parity bits that are to be used for indicating the fault mode register information. For example, the configuration may define that a single parity bit is to be used for indicating the fault mode register information. In another example, the configuration may define that two parity bits, three parity bits, or four parity bits are to be used for indicating the fault mode register information. The memory device may transmit, to the host device, a data burst sequence that includes a plurality of parity bits. The plurality of parity bits may include the one or more parity bits to indicate, to the host device, the fault mode register information in accordance with the configuration. The one or more parity bits may be repurposed to indicate the fault mode register information.

In some implementations, the fault mode register information may include a value to indicate a fault associated with the memory device. In some implementations, the fault mode register information may indicate a fault associated with the memory device, where the fault may be indicated based on a selected parity bit of the plurality of parity bits that is used to indicate the fault mode register information. In some implementations, the fault mode register information may include a first value to indicate that no fault is associated with the memory device or a second value to indicate that a fault is associated with the memory device. The fault may be one of a number of possible faults that are predefined for the memory device.

In some implementations, by repurposing the one or more parity bits to indicate the fault mode register information, the host device may be notified of faults associated with the memory device. The host device may be notified of a specific type of fault associated with the memory device, in which case the host device may not read a fault mode register associated with the memory device. In some cases, the host device may be notified that the fault has occurred, but not the specific type of fault, in which case the host device may read the fault mode register associated with the memory device. In this case, the host device may be able to identify a specific fault mode register to read, instead of having to read a plurality of fault mode registers associated with the memory device. By repurposing the one or more parity bits to indicate the fault mode register information, the host device may be notified of faults associated with the memory device in a reduced amount of time, which may allow the host device to take corrective action in a reduced amount of time. The host device may be able to resolve the fault in a reduced amount of time, as compared to when the one or more parity bits are not repurposed to indicate the fault mode register information, which may improve an overall system performance.

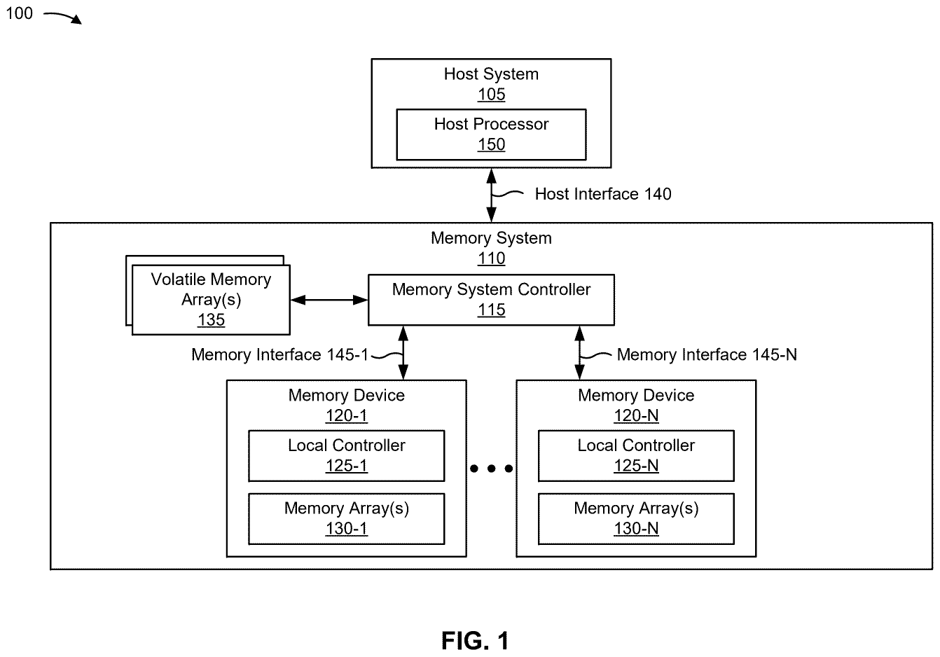

FIG. 1 is a diagram illustrating an example system 100 capable of using parity bits in a data burst sequence to indicate fault mode register information. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to identify a configuration that defines one or more parity bits to be associated with fault mode register information; and transmit, to a host device, a data burst sequence that includes a plurality of parity bits, wherein the plurality of parity bits includes the one or more parity bits to indicate the fault mode register information in accordance with the configuration.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

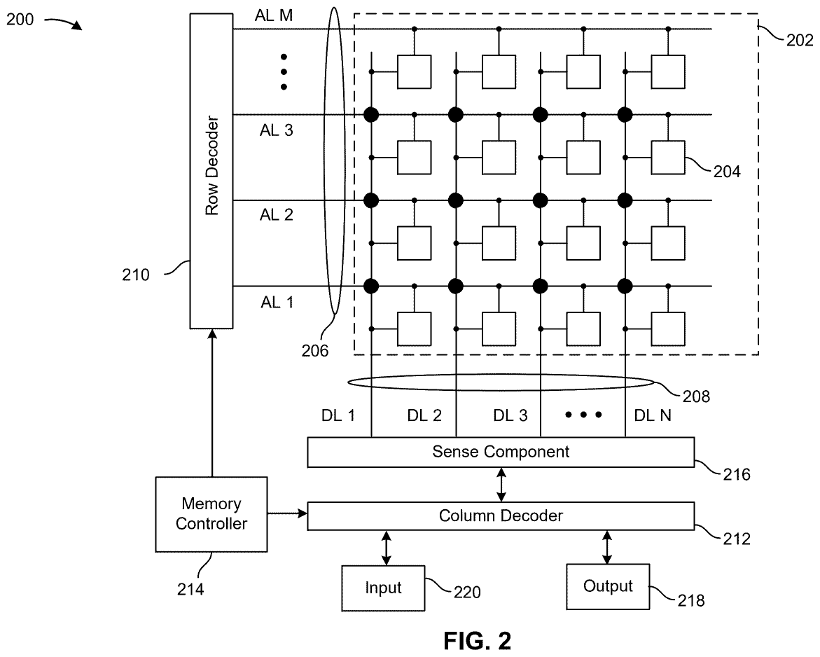

FIG. 2 is a diagrammatic view of an example memory device 200. The memory device 200 may include a memory array 202 that includes multiple memory cells 204. A memory cell 204 is programmable or configurable into a data state of multiple data states (e.g., two or more data states). For example, a memory cell 204 may be set to a particular data state at a particular time, and the memory cell 204 may be set to another data state at another time. A data state may correspond to a value stored by the memory cell 204. The value may be a binary value, such as a binary 0 or a binary 1, or may be a fractional value, such as 0.5, 1.5, or the like. A memory cell 204 may include a capacitor to store a charge representative of the data state. For example, a charged and an uncharged capacitor may represent a first data state and a second data state, respectively. As another example, a first level of charge (e.g., fully charged) may represent a first data state, a second level of charge (e.g., fully discharged) may represent a second data state, a third level of charge (e.g., partially charged) may represent a third data state, and so on.

Operations such as reading and writing (e.g., cycling) may be performed on memory cells 204 by activating or selecting the appropriate access line 206 (shown as access lines AL 1 through AL M) and digit line 208 (shown as digit lines DL 1 through DL N). An access line 206 may also be referred to as a “row line” or a “word line,” and a digit line 208 may also be referred to a “column line” or a “bit line.” Activating or selecting an access line 206 or a digit line 208 may include applying a voltage to the respective line. An access line 206 and/or a digit line 208 may comprise, consist of, or consist essentially of a conductive material, such as a metal (e.g., copper, aluminum, gold, titanium, or tungsten) and/or a metal alloy, among other examples. In FIG. 2, each row of memory cells 204 is connected to a single access line 206, and each column of memory cells 204 is connected to a single digit line 208. By activating one access line 206 and one digit line 208 (e.g., applying a voltage to the access line 206 and digit line 208), a single memory cell 204 may be accessed at (e.g., is accessible via) the intersection of the access line 206 and the digit line 208. The intersection of the access line 206 and the digit line 208 may be called an “address” of a memory cell 204.

In some implementations, the logic storing device of a memory cell 204, such as a capacitor, may be electrically isolated from a corresponding digit line 208 by a selection component, such as a transistor. The access line 206 may be connected to and may control the selection component. For example, the selection component may be a transistor, and the access line 206 may be connected to the gate of the transistor. Activating the access line 206 results in an electrical connection or closed circuit between the capacitor of a memory cell 204 and a corresponding digit line 208. The digit line 208 may then be accessed (e.g., is accessible) to either read from or write to the memory cell 204.

A row decoder 210 and a column decoder 212 may control access to memory cells 204. For example, the row decoder 210 may receive a row address from a memory controller 214 and may activate the appropriate access line 206 based on the received row address. Similarly, the column decoder 212 may receive a column address from the memory controller 214 and may activate the appropriate digit line 208 based on the column address.

The memory cell 204 may be read (e.g., sensed) by a sense component 216 to determine the stored data state of the memory cell 204. For example, after accessing the memory cell 204, the capacitor of the memory cell 204 may discharge onto its corresponding digit line 208. Discharging the capacitor may be based on biasing, or applying a voltage, to the capacitor. The discharging may induce a change in the voltage of the digit line 208, which the sense component 216 may compare to a reference voltage (not shown) to determine the stored data state of the memory cell 204. For example, if the digit line 208 has a higher voltage than the reference voltage, then the sense component 216 may determine that the stored data state of the memory cell 204 corresponds to a first value, such as a binary 1. Conversely, if the digit line 208 has a lower voltage than the reference voltage, then the sense component 216 may determine that the stored data state of the memory cell 204 corresponds to a second value, such as a binary 0. The detected data state of the memory cell 204 may then be output (e.g., via the column decoder 212) to an output component 218 (e.g., a data buffer). A memory cell 204 may be written (e.g., set) by activating the appropriate access line 206 and digit line 208. The column decoder 212 may receive data, such as input from input component 220, to be written to one or more memory cells 204. A memory cell 204 may be written by applying a voltage across the capacitor of the memory cell 204.

The memory controller 214 may control the operation (e.g., read, write, re-write, refresh, and/or recovery) of the memory cells 204 via the row decoder 210, the column decoder 212, and/or the sense component 216. The memory controller 214 may generate row address signals and column address signals to activate the desired access line 206 and digit line 208. The memory controller 214 may also generate and control various voltages used during the operation of the memory array 202.

As indicated above, FIG. 2 is provided as an example. Other examples may differ from what is described with respect to FIG. 2.

DRAM is a type of volatile memory used in electronic devices that stores data temporarily while a system is running. DRAM may lose data when power is turned off. DRAM may require constant refreshing to maintain stored data. DRAM may provide a higher storage capacity as compared to SRAM. DRAM may be slower but more affordable than SRAM. Different types of DRAM may include SDRAM, DDR SDRAM, or high bandwidth memory (HBM). SDRAM may be synchronized with a system clock for better performance. DDR SDRAM may transfer data twice per clock cycle. HBM may be an advanced DRAM for high-performance computing and AI applications.

DRAM may store each bit of data in a capacitor within a memory cell. The memory cell may include the capacitor and a transistor. The capacitor may store an electrical charge representing the bit (1 or 0). The transistor may act as a switch to control access to the capacitor. When writing to DRAM, a memory controller may send a row and column address to locate the memory cell (e.g., a target memory cell). The transistor in the memory cell may open, which may allow charge to flow into the capacitor. A charged capacitor may represent 1, and an uncharged capacitor may represent 0. The transistor may close, thereby storing the data in the capacitor. When reading data from DRAM, the memory controller may select the row and column address. The transistor may open, which may allow stored charge to flow into a sense amplifier. The sense amplifier may detect whether the charge level represents a 1 or a 0. The charge may be restored (refreshed) in the capacitor since reading discharges the capacitor. The data may be sent to a processor for use. Over a period of time, the charge in the capacitor may leak, which may require a periodic refresh cycle to maintain the data. A refresh process may be handled by the memory controller.

Low power double data rate 6 (LPDDR6) DRAM may be associated with improved speed, improved power efficiency, and/or improved bandwidth, as compared to low power double data rate 5 (LP5) DRAM, which may make LPDDR6 DRAM well suited for mobile devices, laptops, and artificial intelligence (AI)-driven applications. LPDDR6 DRAM may employ ECC and/or EDC, which may be used to enhance data integrity, reliability, and stability. ECC is a memory feature that detects and corrects errors in data stored in DRAM. ECC may help prevent data corruption caused by various factors, such as cosmic rays, electrical interference, or manufacturing defects. An ECC-enabled DRAM module may store extra parity bits alongside normal data bits. The extra parity bits may be used to perform Hamming code or Reed-Solomon error correction. When a single bit error occurs, ECC may automatically correct the single bit error. When a multiple bit error occurs, ECC may detect the multiple bit error and prevent the system from using corrupted data. EDC is a memory feature that detects errors but does not correct the errors. EDC may commonly be used alongside ECC in DRAM modules. EDC adds a parity check or checksum bits to each data word. When an error is detected, EDC may notify the system regarding the error (e.g., EDC may be unable to correct the error).

DRAM, such as LPDDR6 DRAM, may have a data burst sequence that outputs 256 bits of data (e.g., payload data or mission data) and 32 bits of metadata. The 32 bits of metadata include 16 bits for system meta carve out and 16 bits for link ECC/EDC or DBI. The 16 bits for system meta carve out are a reservation of system resources for system-level operations. The bits for system meta carve out may be enabled or disabled. The link ECC/EDC may be error correction code or error detection code. DBI involves inverting data bits when certain conditions are satisfied to reduce a number of transitions on a data bus, which may reduce power consumption and electromagnetic interference. The 16 bits for link ECC/EDC or DBI may be used for link ECC/EDC, DBI, or nothing. The 16 bits for link ECC/EDC may enable error detection and correction for the data burst sequence during transmission between a host and a DRAM, or between the DRAM and the host. The 16 bits for link ECC/EDC may protect a link between the host and the DRAM.

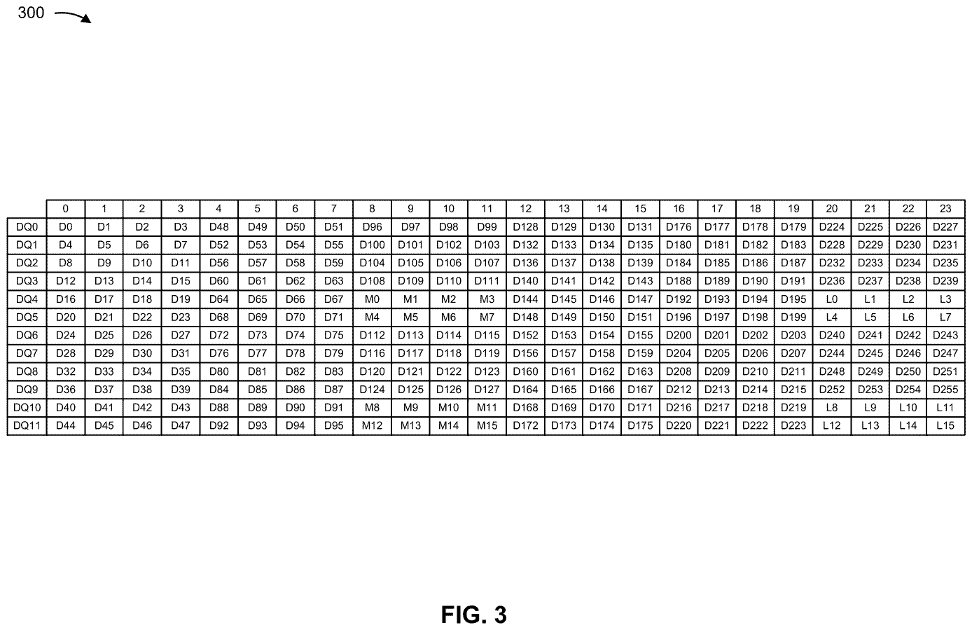

FIG. 3 is a diagram illustrating an example 300 of a data burst sequence.

As shown in FIG. 3, the data burst sequence may output 256 bits of data (e.g., D0 to D256), 16 bits for system meta carve out (e.g., M0 to M15), and 16 bits for link ECC/EDC or DBI (e.g., L0 to L15). Each bit may be associated with a bit storage location.

As indicated above, FIG. 3 is provided as an example. Other examples may differ from what is described with respect to FIG. 3.

DRAM, such as LPDDR6 DRAM, may employ an alert signal to provide a fault notification. When a fault (or error) is encountered by the DRAM, the host may be provided with the fault notification. One fault signal may be employed for a number of different types of faults (or errors) (e.g., one fault signal for any error). After the fault is detected, the host may wait for the DRAM to send the alert signal. The host may receive the alert signal (after some delay) and then interrogate a plurality of devices to determine a source of the fault. For example, a board may have four dies, and each die may have two sub-channels (e.g., total of 8 sub-channels). The host, via an interrogation, may read all 8 sub-channels to determine the source of the fault, which may take an inordinate amount of time. In other words, since only one fault signal may be employed, the host may need to interrogate all devices to determine which die and/or sub-channel had the fault, which may consume the inordinate amount of time. The inordinate amount of time may increase an amount of time needed for the fault to be resolved by the host, thereby degrading an overall system performance.

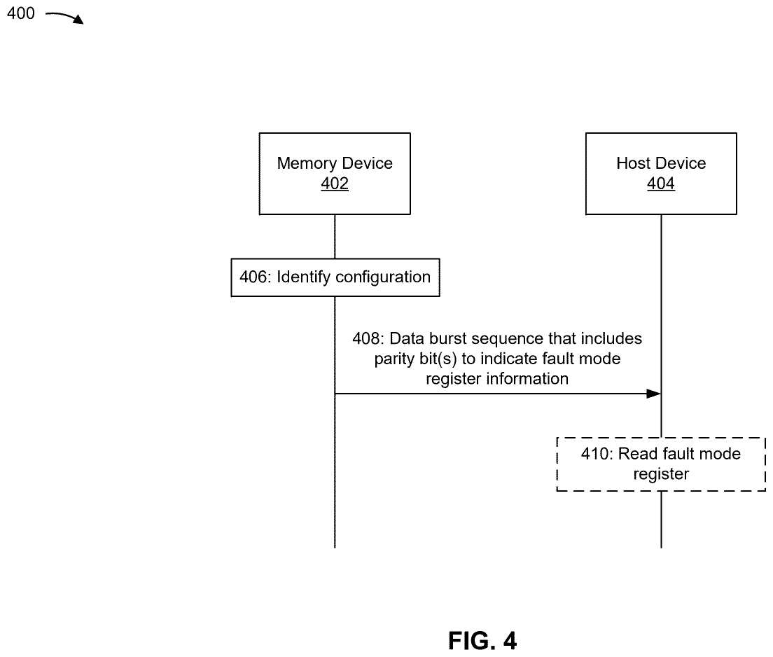

FIG. 4 is a diagram of an example 400 associated with using parity bits in a data burst sequence to indicate fault mode register information. The parity bits may be used to indicate fault information, where the fault information may generally be stored in a fault mode register. The operations described in connection with FIG. 4 may be performed by the memory system 110 and/or one or more components of the memory system 110, such as the memory system controller 115, one or more memory devices 120, and/or one or more local controllers 125.

As shown by reference number 406, a memory device 402 (e.g. memory system 110, such as a DRAM device) may identify a configuration that defines one or more parity bits to be associated with fault mode register information. The fault mode register information may be fault mode registers information when multiple fault mode registers are employed. In other words, the fault mode register information may be associated with a single fault mode register, whereas the fault mode registers information may be associated with multiple fault mode registers. The fault mode register information may correspond to fault information stored in a fault mode register. The memory device 402 may receive the configuration from a host device 404 (e.g., host processor 150). Alternatively, the memory device 402 may be preconfigured with the configuration. The configuration may define a number of parity bits that are to be used for indicating the fault mode register information. For example, the configuration may define that a single parity bit is to be used for indicating the fault mode register information. The single parity bit may be one of 16 parity bits that are available for ECC/EDC. In another example, the configuration may define that two parity bits, three parity bits, or four parity bits are to be used for indicating the fault mode register information. The two parity bits, three parity bits, or four parity bits may be one of 16 parity bits that are available for ECC/EDC. When using Joint Electron Device Engineering Council (JEDEC) defined link ECC/EDC error coding, other error codings may support additional bits to be repurposed.

As shown by reference number 408, the memory device 402 may transmit, to the host device 404, a data burst sequence that includes a plurality of parity bits. The plurality of parity bits may include the one or more parity bits to indicate, to the host device 404, the fault mode register information in accordance with the configuration which may allow a link ECC/EDC operation to still operation while fault information is passed through in real-time. In some implementations, the fault mode register information may include a value to indicate a fault associated with the memory device 402. In some implementations, the fault mode register information may indicate a fault associated with the memory device 402, where the fault may be indicated based on a selected parity bit of the plurality of parity bits that is used to indicate the fault mode register information. For example, when a first parity bit of the 16 parity bits is used, a first type of fault may be indicated. When a second parity bit of the 16 parity bits is used, a second type of fault may be indicated, and so on. In some implementations, the fault mode register information may include a first value to indicate that no fault is associated with the memory device 402, or a second value to indicate that a fault is associated with the memory device 402. The fault may be one of a number of possible faults that are predefined for the memory device 402. For example, when the second value is indicated in the fault mode register information, a presence of the fault may be indicated. However, a specific type of fault may not be indicated. Rather, the fault may be one of the number of possible faults (e.g., 5 possible faults that may occur for the memory device 402), which may be predefined for the memory device 402.

In some implementations, the one or more parity bits may be repurposed to indicate the fault mode register information. An ECC multiple bit error (MBE) diagnostic coverage and an EDC MBE diagnostic coverage may satisfy a threshold based on the one or more parity bits being repurposed to indicate the fault mode register information. In other words, even though the one or more parity bits may be repurposed and may no longer be used for ECC/EDC, the ECC MBE diagnostic coverage and the EDC MBE diagnostic coverage may still satisfy a certain performance threshold. In some implementations, the plurality of parity bits may be associated with ECC/EDC, and remaining parity bits (e.g., parity bits that are not repurposed to indicate the fault mode register information) may be used for ECC/EDC. The remaining parity bits that are usable for ECC/EDC may include one or more bits.

As shown by reference number 410, the host device 404 may determine whether to read a fault mode register of the memory device 402 based on the fault mode register information. The memory device 402 may include one or more fault mode registers that are readable by the host device 404, where each fault mode register, of the one or more fault mode registers, may be associated with a sub-channel of the memory device 402. The host device 404 may be able to read one of the fault mode registers based on the fault mode register information indicated via the one or more parity bits.

In some implementations, when the fault mode register information includes the value to indicate the fault associated with the memory device 402, the host device 404 may not read the fault mode register of the memory device 402 based on the fault mode register information indicating the fault. In other words, the fault mode register information may already indicate a specific fault associated with the memory device 402. In some implementations, when the fault mode register information includes the first value to indicate no fault or the second value to indicate the fault, where the fault may be one of the number of possible faults that are predefined for the memory device 402, the host device 404 may read the fault mode register of the memory device 402 based on the fault mode register information. In other words, the host device 404 may not be notified that the fault is present, but the host device 404 may not have information regarding a specific type of fault that is associated with the memory device 402. In this case, the host device 404 may then read the fault mode register to obtain information regarding the specific type of fault.

In some implementations, the memory device 402 (e.g., DRAM, such as LPDDR6 DRAM) may employ link ECC/EDC for error detection and correction. The data burst sequence may include 256 mission data bits, 16 system meta mode bits, and 16 parity bits. The 16 parity bits may be allocated for an ECC/EDC function of the 256 data bits plus the 16 system meta mode bits (272 bits). When all 16 parity bits are employed, ECC may be associated with approximately 100% single bit error (SBE) correction and approximately 99.5% MBE diagnostic coverage. When all 16 parity bits are employed, EDC may be associated with approximately 99.998% SBE/MBE diagnostic coverage. The parity bits may include H-matrix parity bits, which may also be referred to as check bits.

As an example, 16 ECC bits may be associated with an ECC MBE of approximately 99.559% and an EDC MBE of approximately 99.998%. 15 ECC bits may be associated with an ECC MBE of approximately 99.12% and an EDC MBE of approximately 99.997%. 14 ECC bits may be associated with an ECC MBE of approximately 98.25% and an EDC MBE of approximately 99.994%. 13 ECC bits may be associated with an ECC MBE of approximately 96.51% and an EDC MBE of approximately 99.988%. 12 ECC bits may be associated with an ECC MBE of approximately 93.04% and an EDC MBE of approximately 99.976%. 11 ECC bits may be associated with an ECC MBE of approximately 86.13% and an EDC MBE of approximately 99.951%. 10 ECC bits may be associated with an ECC MBE of approximately 72.36% and an EDC MBE of approximately 99.902%. 9 ECC bits may be associated with an ECC MBE of approximately 44.9% and an EDC MBE of approximately 99.805%.

In some implementations, not all 16 parity bits may be required for an ECC/EDC function. For example, as few as 9 parity bits may be required. When 9 parity bits are used for the ECC/EDC function, ECC may be associated with an approximately 44.9% MBE diagnostic coverage and EDC may be associated with an approximately 98.805% MBE diagnostic coverage. Using less than the 16 parity bits may involve the memory device 402 and the host device 404 realigning bits in an H-matrix.

In some implementations, 256 data bits, 16 system meta mode bits, and 9 to 15 parity bits may be employed for ECC/EDC. For example, ECC may be associated with 272 bits plus 16 bits and EDC may be associated with 272 bits plus a number of parity bits that is greater than or equal to 9 and less than or equal to 15. In this case, 1 to 7 parity bits may be used for other information, such as fault mode register information. The fault mode information may indicate information regarding a specific type of fault associated with the memory device 402. As another example, ECC and EDC may be associated with 272 bits plus a number of parity bits that is greater than or equal to 9 and less than or equal to 15. In this case, ECC may not be desired due to a relatively low diagnostic coverage in most cases.

In some implementations, the fault mode register based information may be obtained by reallocating one parity bit of the 16 parity bits in an existing 272+16 H-matrix. Repurposing the one parity bit may allow a receiver to achieve an approximately 100% SBE detection/correction with a relatively high MBE diagnostic coverage. Repurposing the one parity bit may not involve a realignment of the H-matrix. The memory device 402 may repurpose any one parity bit of the 16 parity bits (e.g., check bit 15 (CB15)). In this case, approximately 100% SBE correction may be supported with a slightly less MBE detection in ECC mode, or a relatively high MBE diagnostic coverage may be supported in an EDC mode (e.g., a change from approximately 99.998% to approximately 99.997%).

In some implementations, by repurposing the one bit of the 16 parity bits, the one bit may be used for providing the fault mode register information. The one bit (that is repurposed from a parity bit) may be used to indicate the fault mode register information, which may cause the host device 404 to read a fault mode register of the memory device 402, which may reduce time and/or resources needed by the host device 404 to determine a source/location/reason of the fault. The fault mode register may be populated due to a fault. In other words, when the fault occurs by different functions, the fault mode register may be populated due to the fault. The fault mode register information indicated via the one parity bit may trigger the host device 404 to read the fault mode register.

In some implementations, up to 4 parity bits of the 16 parity bits in the existing JEDEC defined 272+16 H-matrix may be reallocated to provide an additional amount of fault mode register information. The additional fault mode register information may be obtained by allocating up to 4 parity bits in the existing 272+16 H-matrix. Repurposing the up to 4 parity bits may not involve a realignment of the H-matrix for EDC support. Repurposing the up to 4 parity bits may not support an ECC operation because approximately 39% of SBE may alias one or more additional corrections. The memory device 402 may repurpose any 4 parity bits of the 16 parity bits, e.g., CB12, CB13, CB14, and/or CB15. An ECC mode may not be supported but may have a relatively high MBE diagnostic coverage in an EDC mode (e.g., a change from approximately 99.998% to approximately 99.976%).

In some implementations, the memory device 402 may operate with a standard link ECC/EDC, or the host device 404 may select an option for link ECC/EDC with fault mode register information. When one parity bit of the 16 parity bits is repurposed, the memory device 402 may replace one parity bit (e.g., CB15) with the fault mode register information.

In some implementations, the host device 404 may be allowed to select one of 16 faults to signal (e.g., which fault to signal may be programmable). For example, when a bit associated with L1 is repurposed, a first type of fault may be indicated to the host device 404. When a bit associated with L2 is repurposed, a second type of fault may be indicated to the host device 404, and so on. The host device 404 may be allowed to select one of 15 fault mode register faults to signal.

In some implementations, the host device 404 may be allowed to select the memory device's predefined fault mode register support. The one parity bit may be set accordingly depending on whether the fault is detected. For example, the one parity bit (e.g., CB15) may be set to “0” unless the fault is detected. The one parity bit may be set to “0” to indicate no fault or the one parity bit may be set to “1” to indicate a presence of the fault. In this example, “1” and “0” may be used to indicate whether or not the fault is present. The fault may be associated with a fault mode register output (output fault register). The fault may be associated with a practical (PRAC) limit, a write link ECC MBE, a write link EDC SBE/MBE fault, an on-die ECC SBE threshold fault, an on-die ECC MBE fault, a parity fault, or a refresh rate change. In another example, the one parity bit (e.g., CB15) may cover the PRAC limit, the write link ECC MBE, the write link EDC SBE/MBE fault, the on-die ECC SBE threshold fault, the on-die ECC MBE fault, the parity fault, and the refresh rate change, plus the one parity bit (e.g., CB15) may cover at least a register fault, a syndrome check fault, or a high on a valid read operation (VROF). In this example, the one parity bit may be set to “1” (e.g., due to VROF), and any covered fault may result in the one parity bit being set to “0”. The host device 404 may receive the one parity bit that indicates the fault mode register information, and then the host device 404 may read the fault mode register of the memory device 402. In other words, when the host device 404 detects a fault from the one parity bit (e.g., CB15), the host device 404 may read the fault mode register to obtain additional information regarding the fault. Each sub-channel may provide the fault mode register information in real-time, so the host device 404 may be able to determine which fault mode register to read, as opposed to reading a plurality of fault mode registers for a plurality of different sub-channels.

In some implementations, the memory device 402 may operate with a standard link ECC/EDC, or the host device 404 may select an option for link ECC/EDC with 4 fault mode register informations. When 4 parity bits of the 16 parity bits are repurposed, the memory device 402 may replace 4 parity bits (e.g., CB15) with fault mode register information.

In one example, one parity bit (e.g., CB15) may correspond to a set of different faults, which may include the PRAC limit, the write link ECC MBE, the write link EDC SBE/MBE fault, the on-die ECC SBE threshold fault, the on-die ECC MBE fault, and the parity fault. The one parity bit may be set to “0”, unless a fault is detected, in which case the one parity bit may be set to “1”. In this example, “1” and “0” may be used to indicate whether or not the fault is present. In some implementations, all 4 parity bits may be repurposed to indicate the fault mode register information. Alternatively, one parity bit, two parity bits, or three parity bits may be repurposed to indicate the fault mode register information. The host device 404 may ignore an internal link ECC/EDC CB15 when determining the syndrome. In one example, the write link ECC MBE, the write link EDC SBE/MBE fault, and/or the parity fault may provide an earlier fault notice when an alert is routed, as compared to when the alert is not routed.

In one example, one parity bit (e.g., CB14) may correspond to the register fault. The one parity bit may be set to “0”, unless a fault is detected, in which case the one parity bit may be set to “1”. In this example, “1” and “0” may be used to indicate whether or not this fault is present. In this example, the host device 404 may not need to read the fault mode register because the one parity indicates the exact type of fault that is present.

In one example, one parity bit (e.g., CB13) may correspond to the syndrome fault. The one parity bit may be set to “0”, unless a fault is detected, in which case the one parity bit may be set to “1”. In this example, “1” and “0” may be used to indicate whether or not this fault is present. In this example, the host device 404 may not need to read the fault mode register because the one parity indicates the exact type of fault that is present.

In one example, one parity bit (e.g., CB12) may correspond to the VROF. The one parity bit may be set to “0”, unless a fault is detected, in which case the one parity bit may be set to “1”. In this example, “1” and “0” may be used to indicate whether or not the VROF is present. In this example, the host device 404 may not need to read the fault mode register because the one parity indicates the exact type of fault that is present.

In one example, out of the 4 parity bits, a first set of two parity bits may correspond to a first set of faults and a second set of two parity bits may correspond to a second set of faults. When the first set is set to “1”, an occurrence of a fault from the first set of faults may be indicated. When the second set is set to “1”, an occurrence of a fault from the second set of faults may be indicated. In this manner, all 4 parity bits may be used to indicate an occurrence of a fault and/or a specific fault that has occurred.

As indicated above, FIG. 4 is provided as an example. Other examples may differ from what is described with regard to FIG. 4.

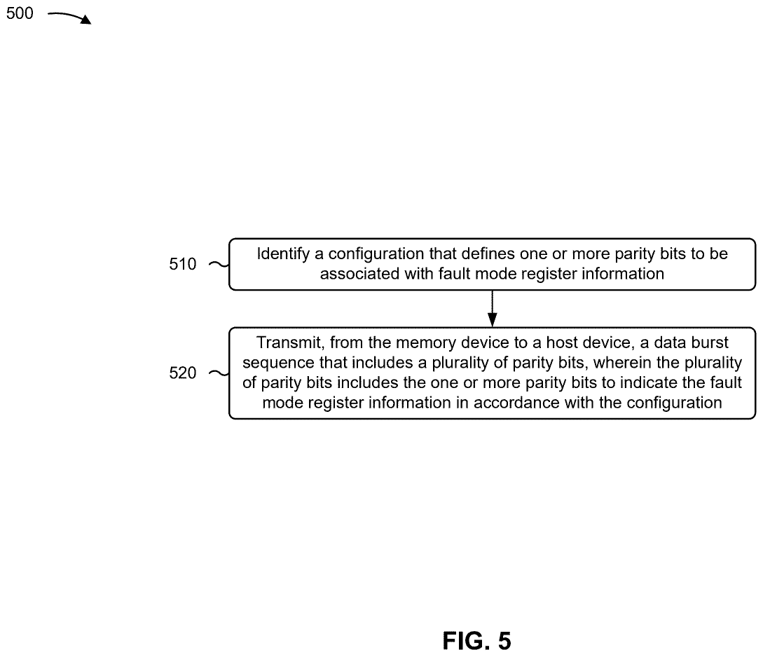

FIG. 5 is a flowchart of an example method 500 associated with using parity bits in a data burst sequence to indicate fault mode register information. In some implementations, a memory device (e.g., the memory device 120) may perform or may be configured to perform the method 500. In some implementations, another device or a group of devices separate from or including the memory device (e.g., the system 100) may perform or may be configured to perform the method 500. Additionally, or alternatively, one or more components of the memory device may perform or may be configured to perform the method 500. Thus, means for performing the method 500 may include the memory device and/or one or more components of the memory device. Additionally, or alternatively, a non-transitory computer-readable medium may store one or more instructions that, when executed by the memory device (e.g., the controller 130 of the memory device 120), cause the memory device to perform the method 500.

As shown in FIG. 5, the method 500 may include identifying a configuration that defines one or more parity bits to be associated with fault mode register information (block 510). As further shown in FIG. 5, the method 500 may include transmitting, from the memory device to a host device, a data burst sequence that includes a plurality of parity bits, wherein the plurality of parity bits includes the one or more parity bits to indicate the fault mode register information in accordance with the configuration (block 520).

The method 500 may include additional aspects, such as any single aspect or any combination of aspects described below and/or described in connection with one or more other methods or operations described elsewhere herein.

In a first aspect, the fault mode register information includes a value to indicate a fault associated with the memory device.

In a second aspect, alone or in combination with the first aspect, the fault mode register information indicates a fault associated with the memory device, and the fault is indicated based on a selected parity bit of the plurality of parity bits that is used to indicate the fault mode register information.

In a third aspect, alone or in combination with one or more of the first and second aspects, the fault mode register information includes a first value to indicate that no fault is associated with the memory device or a second value to indicate that a fault is associated with the memory device, and the fault is one of a number of possible faults that are predefined for the memory device.

In a fourth aspect, alone or in combination with one or more of the first through third aspects, the configuration defines that the one or more parity bits is a single parity bit, two parity bits, three parity bits, or four parity bits.

In a fifth aspect, alone or in combination with one or more of the first through fourth aspects, the one or more parity bits are repurposed to indicate the fault mode register information, and an ECC MBE diagnostic coverage and an EDC MBE diagnostic coverage satisfies a threshold based on the one or more parity bits being repurposed to indicate the fault mode register information.

In a sixth aspect, alone or in combination with one or more of the first through fifth aspects, the plurality of parity bits are associated with ECC or EDC, and remaining parity bits that are not used for indicating the fault mode register information are used for ECC or EDC.

In a seventh aspect, alone or in combination with one or more of the first through sixth aspects, the memory device includes one or more fault mode registers that are readable by the host device, and each fault mode register, of the one or more fault mode registers, is associated with a sub-channel of the memory device.

In an eighth aspect, alone or in combination with one or more of the first through seventh aspects, the memory device is a DRAM device.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

In some implementations, a memory device includes one or more components configured to: identify a configuration that defines one or more parity bits to be associated with fault mode register information; and transmit, to a host device, a data burst sequence that includes a plurality of parity bits, wherein the plurality of parity bits includes the one or more parity bits to indicate the fault mode register information in accordance with the configuration.

In some implementations, a method includes identifying, by a memory device, a configuration that defines one or more parity bits to be associated with fault mode register information; and transmitting, from the memory device to a host device, a data burst sequence that includes a plurality of parity bits, wherein the plurality of parity bits includes the one or more parity bits to indicate the fault mode register information in accordance with the configuration.

In some implementations, a system includes a host device; and a memory device configured to: identify a configuration that defines one or more parity bits to be associated with fault mode register information; and transmit, to the host device, a data burst sequence that includes a plurality of parity bits, wherein the plurality of parity bits includes the one or more parity bits to indicate the fault mode register information in accordance with the configuration.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
one or more components configured to:
identify a configuration that defines one or more parity bits to be associated with fault mode register information; and
transmit, to a host device, a data burst sequence that includes a plurality of parity bits, wherein the plurality of parity bits includes the one or more parity bits to indicate the fault mode register information in accordance with the configuration.

2. The memory device of claim 1, wherein the fault mode register information includes a value to indicate a fault associated with the memory device.

3. The memory device of claim 1, wherein the fault mode register information indicates a fault associated with the memory device, and wherein the fault is indicated based on a selected parity bit of the plurality of parity bits that is used to indicate the fault mode register information.

4. The memory device of claim 1, wherein the fault mode register information includes a first value to indicate that no fault is associated with the memory device or a second value to indicate that a fault is associated with the memory device, and wherein the fault is one of a number of possible faults that are predefined for the memory device.

5. The memory device of claim 1, wherein the configuration defines that the one or more parity bits is a single parity bit.

6. The memory device of claim 1, wherein the configuration defines that the one or more parity bits is two parity bits, three parity bits, or four parity bits.

7. The memory device of claim 1, wherein the one or more parity bits are repurposed to indicate the fault mode register information, and wherein an error correction code multiple bit error diagnostic coverage and an error detection code multiple bit error diagnostic coverage satisfies a threshold based on the one or more parity bits being repurposed to indicate the fault mode register information.

8. The memory device of claim 1, wherein the plurality of parity bits are associated with error correction code (ECC) or error detection code (EDC), and wherein remaining parity bits that are not used for indicating the fault mode register information are used for ECC or EDC.

9. The memory device of claim 1, wherein the memory device includes one or more fault mode registers that are readable by the host device, and wherein each fault mode register, of the one or more fault mode registers, is associated with a sub-channel of the memory device.

10. The memory device of claim 1, wherein the memory device is a dynamic random access memory (DRAM) device.

11. A method, comprising:
identifying, by a memory device, a configuration that defines one or more parity bits to be associated with fault mode register information; and
transmitting, from the memory device to a host device, a data burst sequence that includes a plurality of parity bits, wherein the plurality of parity bits includes the one or more parity bits to indicate the fault mode register information in accordance with the configuration.

12. The method of claim 11, wherein the fault mode register information includes a value to indicate a fault associated with the memory device.

13. The method of claim 11, wherein the fault mode register information indicates a fault associated with the memory device, and wherein the fault is indicated based on a selected parity bit of the plurality of parity bits that is used to indicate the fault mode register information.

14. The method of claim 11, wherein the fault mode register information includes a first value to indicate that no fault is associated with the memory device or a second value to indicate that a fault is associated with the memory device, and wherein the fault is one of a number of possible faults that are predefined for the memory device.

15. The method of claim 11, wherein the configuration defines that the one or more parity bits is a single parity bit, two parity bits, three parity bits, or four parity bits.

16. The method of claim 11, wherein the one or more parity bits are repurposed to indicate the fault mode register information, and wherein an error correction code multiple bit error diagnostic coverage and an error detection code multiple bit error diagnostic coverage satisfies a threshold based on the one or more parity bits being repurposed to indicate the fault mode register information.

17. The method of claim 11, wherein the plurality of parity bits are associated with error correction code (ECC) or error detection code (EDC), and wherein remaining parity bits that are not used for indicating the fault mode register information are used for ECC or EDC.

18. The method of claim 11, wherein the memory device includes one or more fault mode registers that are readable by the host device, and wherein each fault mode register, of the one or more fault mode registers, is associated with a sub-channel of the memory device.

19. The method of claim 11, wherein the memory device is a dynamic random access memory (DRAM) device.

20. A system, comprising:
a host device; and
a memory device configured to:
identify a configuration that defines one or more parity bits to be associated with fault mode register information; and
transmit, to the host device, a data burst sequence that includes a plurality of parity bits, wherein the plurality of parity bits includes the one or more parity bits to indicate the fault mode register information in accordance with the configuration.

21. The system of claim 20, wherein the fault mode register information includes a value to indicate a fault associated with the memory device, and wherein the host device is configured to determine to not read a fault mode register of the memory device based on the fault mode register information indicating the fault.

22. The system of claim 20, wherein the fault mode register information includes a first value to indicate that no fault is associated with the memory device or a second value to indicate that a fault is associated with the memory device, wherein the fault is one of a number of possible faults that are predefined for the memory device, and wherein the host device is configured to read a fault mode register of the memory device based on the fault mode register information.

23. The system of claim 20, wherein the one or more parity bits are repurposed to indicate the fault mode register information, and wherein an error correction code multiple bit error diagnostic coverage and an error detection code multiple bit error diagnostic coverage satisfies a threshold based on the one or more parity bits being repurposed to indicate the fault mode register information.

24. The system of claim 20, wherein the plurality of parity bits are associated with error correction code (ECC) or error detection code (EDC), and wherein remaining parity bits that are not used for indicating the fault mode register information are used for ECC or EDC.

25. The system of claim 20, wherein the memory device includes one or more fault mode registers, wherein each fault mode register, of the one or more fault mode registers, is associated with a sub-channel of the memory device, and wherein the host device is configured to read one of the fault mode registers based on the fault mode register information indicated via the one or more parity bits.
